(19) United States
(12) Patent Application Publication
(10) Pub. No.: US 2008/0034757 A1
(43) Pub. Date: Feb. 14, 2008

(54) Method and system integrating solar heat into a regenerative rankine cycle

(76) Inventors: Mark Joseph Skowronski, Irvine, CA (US); Ronald Farris Kincaid, Los Alamitos, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/894,033

(22) Filed: Aug. 17, 2007

Related U.S. Application Data
(63) Continuation-in-part of application No. 11/440,493, filed on May 25, 2006.
(60) Provisional application No. 60/684,845, filed on May 27, 2005.

(51) Int. Cl. F03G 6/00

(52) U.S. Cl. 60/641.8

(57) ABSTRACT

Systems and methods of integrating solar energy into a Rankine cycle power generation system can enhance efficiency of the system. Solar heat can be collected in an array of solar heat collectors. The solar heat collectors can use solar energy to heat a single phase thermal transfer fluid, which can be circulated in a solar heat system. The solar heat system includes a closed loop working fluid heater fluidly coupled to the solar heat collectors that transfers heat energy from the thermal transfer fluid to a working fluid of the power generation system. Thus, the working fluid is preheated before it enters the boiler of the power generation system. The solar working fluid heater can be connected in a regeneration portion of the Rankine cycle downstream of other working fluid heaters, or upstream of at least one working fluid heater. The solar heat input can reduce the fuel consumption of the boiler.

### CROSS-REFERENCE TO RELATED APPLICATIONS

This application is a continuation-in-part of U.S. patent application Ser. No. 11/440,493, entitled “METHOD AND SYSTEM INTEGRATING SOLAR HEAT INTO A REGENERATIVE RANKINE STEAM CYCLE,” filed on May 25, 2006, pending, which claims priority to U.S. Provisional Patent Application No. 60/684,845, “METHOD TO INTEGRATE SOLAR THERMAL WITH A COAL FIRED RANKINE CYCLE” filed on May 27, 2005. Both of these applications are incorporated herein by reference in their entireties.

### BACKGROUND OF THE INVENTION

1. Field of the Invention

The application relates generally to systems and methods for power generation and more specifically to systems and methods for integrating a regenerative Rankine cycle power generation system with a solar energy collection system to achieve enhanced power generation efficiency.

2. Description of the Related Art

Rankine cycle power generation systems generate power by alternately vaporizing and condensing a working fluid. In a typical Rankine cycle power plant, the working fluid is vaporized in a boiler to which heat energy is added such as by the combustion of a fossil fuel such as coal. The vapor is then expanded through a turbine to generate power output. Many fossil fueled Rankine cycle power generation systems use both reheat and regeneration in an attempt to raise the cycle efficiency. Reheat includes returning some of the vaporized working fluid that has been partially expanded in the turbine to the boiler for additional heating before continued expansion in the turbine. Regeneration can limit condenser loss in the power generation system by using partially-expanded vaporized working fluid to pre-heat working fluid before it is vaporized in the boiler.

Attempts have been made to reduce reliance on sources of fossil fuel by integrating collection of solar energy into a power generation system. For example, in a solar Rankine power generation system, a solar boiler uses solar energy to vaporize a working fluid, which can be expanded through a turbine and condensed to begin the cycle anew. Such solar thermal generation facilities require the use of a fairly complex solar boiler and are relatively inefficient. Thus, solar Rankine power generation systems cannot compete, in most cases, with traditional fossil fuel generated electrical energy. Additionally, solar Rankine power generation systems can not operate (without fossil-fuel back up) during severe overcast or night hours. Other attempts have been made to integrate solar power generation with a fossil-fuel power generation system by, for example, using solar heat to vaporize a working fluid in a solar boiler before it is superheated by the combustion of fossil fuel. Such attempts have required fairly complex solar boilers. Still other attempts have been made to integrate solar power generation with a fossil-fuel power generation system by, for example, using solar energy to heat a portion of the working fluid at a relatively cool location on the working fluid cycle.

### SUMMARY OF THE INVENTION

In various embodiments, systems and methods for integrating solar energy with a Rankine power generation system are provided herein. As further described herein, the systems and methods can increase efficiency of a Rankine cycle power generation system without the shortcomings noted above. In some embodiments, the systems and methods can incorporate solar energy to increase power generation of a Rankine power generation system without requiring additional fossil fuel to be consumed. In other embodiments, the systems and methods can incorporate the solar energy such that a substantially constant power output is obtained while a fossil fuel input requirement is reduced. Still other embodiments can include various combinations and permutations of the aspects described in further detail below.

In certain embodiments, a method for generating power is provided. The method comprises heating a thermal transfer fluid with solar energy in a single phase system and transferring heat energy from the heated thermal transfer fluid to a working fluid in a Rankine cycle power generation system to preheat the working fluid. Heat energy is transferred from the heated thermal transfer fluid to the working fluid in a regeneration portion of the Rankine cycle power generation system in a closed loop system of a solar working fluid heater wherein the solar working fluid heater is not located in a storage tank. The solar working fluid heater is fluidly coupled in series with and downstream of a first working fluid heater.

In other embodiments, a system for generating power is provided. The system comprises a boiler, a turbine, a condenser, a generator, and a regeneration cycle. The boiler is configured to vaporize a working fluid. The turbine is fluidly coupled to the boiler and configured to be driven by the vaporized working fluid. The condenser is fluidly coupled to the turbine and configured to condense the working fluid that has driven the turbine. The generator is operatively coupled to the turbine. The regeneration cycle is fluidly coupled to the condenser and the boiler. The regeneration cycle comprises a first working fluid heater and a second working fluid heater. The first working fluid heater is configured to preheat the condensed working fluid from the condenser. The first working fluid heater is configured to receive partially expanded vaporized working fluid from the turbine and to transfer heat energy from the partially expanded vaporized working fluid to the condensed working fluid. The second working fluid heater is serially coupled to the first working fluid heater and configured to preheat the condensed working fluid from the condenser. The second working fluid heater is configured to receive a thermal transfer fluid from a solar heat collection system and to transfer heat energy from the solar heat collection system to the condensed working fluid.

### BRIEF DESCRIPTION OF THE DRAWINGS

The above-mentioned and the other features of the inventions disclosed herein are described below with reference to the drawings of the preferred embodiments. The illustrated embodiments are intended to illustrate, but not to limit the inventions. The drawings contain the following figures:

FIG. 1 is a schematic diagram of a Rankine cycle power generation system of the prior art;

FIG. 2 is a schematic diagram of one embodiment of Rankine cycle power generation system having a solar heat system integrated into a regeneration cycle;

FIG. 3 is a schematic diagram of the Rankine cycle power generation system of FIG. 2 having a transfer fluid reservoir in the solar heat system;

FIG. 4 is a schematic diagram of another embodiment of Rankine cycle power generation system having a solar heat system integrated into the regeneration cycle;

FIG. 5 is a schematic diagram of the Rankine cycle power generation system of FIG. 4 having a transfer fluid reservoir in the solar heat system.

### DETAILED DESCRIPTION OF THE PREFERRED EMBODIMENT

The following discussion describes in detail several embodiments of power generation systems and various aspects of these embodiments. This discussion should not be construed, however, as limiting the present inventions to those particular embodiments. Practitioners skilled in the art will recognize numerous other embodiments including those that can be made through various combinations of the aspects of the illustrated embodiments.

Exemplary Rankine Power Generation System

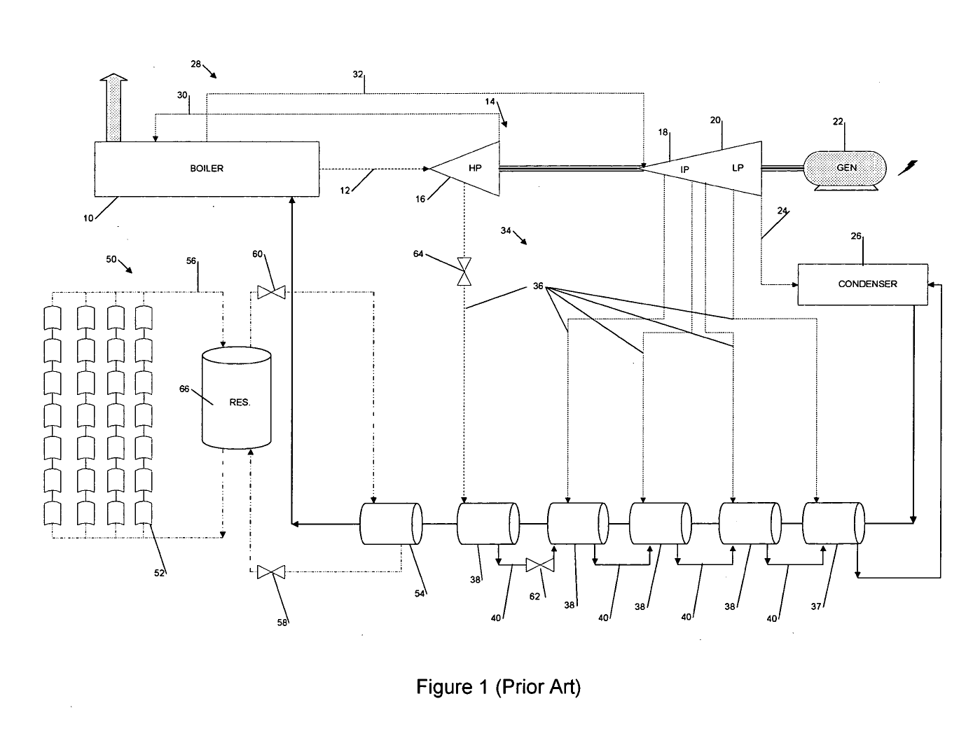

With reference to FIG. 1, an exemplary Rankine power generation system of the prior art is illustrated. In general, a Rankine power generation system can generate power through the vaporization and condensation of a working fluid in a heat cycle. In the illustrated Rankine cycle power generation system, vaporization of the working fluid is accomplished in a boiler 10, with energy provided by the combustion of a fossil fuel, such as by the burning of coal. A coal-fueled Rankine cycle power generation system is discussed herein with respect to the illustrated embodiments as coal-fueled power generation systems can be particularly well suited to supplementation with solar heat. It is contemplated that in other embodiments, the systems and methods described herein can be used in other fossil fueled (including natural gas) or nuclear fueled boiler power generation systems and most other regenerative steam Rankine power cycles. The working fluid can be water, which, upon the addition of sufficient heat energy, can vaporize into water steam. A main steam line 12 can fluidly couple the boiler 10 to a turbine 14 over which the vaporized working fluid is expanded, thus driving the turbine.

With continued reference to FIG. 1, in the illustrated exemplary Rankine power generation system, the turbine 14 comprises multiple turbine stages to extract energy from the vaporized working fluid at different pressure ranges. As illustrated, the turbine 14 comprises a high pressure turbine stage 16 configured to receive vaporized working fluid directly from the boiler 10 over the fluid line 12, an intermediate pressure turbine stage 18, and a low pressure turbine stage 20. As further described below, multiple turbine pressure stages allow the Rankine power generation system to incorporate reheating of the working fluid to further increase efficiency of the power generation system. In other Rankine cycle power generation systems, the turbine could include more or fewer than three turbine pressure stages over which the working fluid is expanded. The turbine 14 is operatively coupled to a generator 22, which can convert the rotation of an output shaft of the turbine 14 into electrical energy. Various types of generators 22 can accomplish this generation of electrical energy.

With continued reference to FIG. 1, after being expanded over the turbine 14, the working fluid is routed to a turbine outlet line 24 fluidly coupling the turbine 14 to a condenser 26. The condenser allows for the working fluid to be cooled and to condense into a liquid state. The working fluid can then be returned to the boiler 10 where the cycle begins again.

In the exemplary Rankine cycle power generation system, both reheat and regeneration are incorporated to increase efficiency of the system. In the illustrated Rankine cycle power generation system, a reheat cycle 28 includes a cold reheat return line 30 fluidly coupling the high pressure turbine stage 16 of the turbine 14 to the boiler 10. A portion of the partially-expanded working fluid is drawn from the high pressure turbine stage 16 and returned to the boiler 10 over the cold reheat return line 30. Once heat energy has been added, this ‘reheated’ working fluid is transported over a hot reheat line 32 fluidly coupling the boiler 10 to the intermediate pressure turbine stage 18, where the reheated working fluid is expanded. Advantageously, a reheat cycle 28 increases efficiency of the power generation system. Further, the reheat cycle and multiple pressure stages in the turbine can reduce the risk that the working fluid will condense on the turbine during the expansion cycle. Some power generation systems can include more than one reheat cycle.

With continued reference to FIG. 1, a regeneration cycle 34 is incorporated in the illustrated Rankine cycle power generation system to further increase the efficiency of the system. In the regeneration cycle, partially-expanded working fluid is drawn from one or more locations in the turbine 14 by working fluid extraction lines 36 fluidly coupling the turbine 14 to at least one working fluid heater 38. In the illustrated power generation system, five working fluid extraction lines draw partially-expanded working fluid from five locations on the turbine 14 and route this working fluid to five working fluid heaters 38. In other power generation systems, more or fewer than five working fluid heaters 38 can be included in a regeneration cycle. The regeneration cycle 34 increases the temperature of the working fluid being fed to the boiler 10, thus increasing the temperature at which heat is added to the working fluid in the boiler, which increases the efficiency of the power generation system. Furthermore, the extracted working fluid that is drawn to the working fluid heaters can be progressively drained in a series of heater drain lines 40 to the condenser 26. Thus, the working fluid can provide a ‘heat sink’ for the condenser, which can reduce the quantity of heat rejected through the condenser 26.

With reference to the working fluid heaters 38 illustrated in FIG. 1, regeneration can be accomplished using either open or closed working fluid heaters, or a combination thereof. In power generation systems with open working fluid heaters, the extracted working fluid from the turbine 14 is mixed directly with the condensed working fluid flow from the condenser 26.

In a power generation system having closed working fluid heaters 38, the extracted working fluid from the turbine 14 is not mixed with the condensed working fluid from the condenser 26, but heat energy is transferred from the extracted working fluid to the condensed working fluid. One example of a closed working fluid heater is a tube and shell-style heater.

Many power generation systems include a combination of an open working fluid heater and closed working fluid heaters. For example, some power generation systems include a deaerator 37 as a first (i.e. closest to the condenser) working fluid heater. A deaerator 37 is an open working fluid heater that can remove gases from the working fluid. A deaerator 37 can include a working fluid pump at both the feed inlet and outlet. In some power generation systems, one or more closed working fluid heaters 38 can be fluidly coupled downstream of the deaerator 37 to form a working fluid heater train.

Integration of Solar Heat System with Regenerative Rankine Cycle Power Generation System

In various embodiments, solar heat energy can be used to supplement power generation by large utility-sized power plants as can be used to generate electricity. It is contemplated that fossil fuel energy costs will continue on an upward trend and will not abate since fossil fuels have a finite limit. As the finite quantity decreases with use, the growing demand for electricity will ultimately lead to significantly higher electricity costs. Thus, the solar supplemented Rankine cycle power generation systems and methods described herein can provide ever increasing cost benefits in the field of electrical power generation. The systems and methods described in further detail herein can utilize collected solar energy to provide supplemental heat into a Rankine cycle power generation system. One advantage of the described systems and methods is that, in some embodiments, they can “piggyback” on existing components and infrastructure of an operational Rankine cycle power plant. Thus, the systems and methods described herein can be applied in a relatively low cost retrofit to an operational power generation system. Additionally, the methods and systems described herein can provide further economies as they can operate with the addition of relatively non-complex, low cost hardware: in some embodiments, a solar boiler, solar feedwater train and solar steam turbine-generator are not needed to achieve the benefits of the described systems and methods. Instead, these relatively higher complexity and cost components can be supplied in the fossil-fueled Rankine cycle, which can be supplemented by solar supplied heat as described herein. Thus, the solar-supplemented Rankine cycle power generation systems can provide a significant reduction in the cost of solar produced electricity.

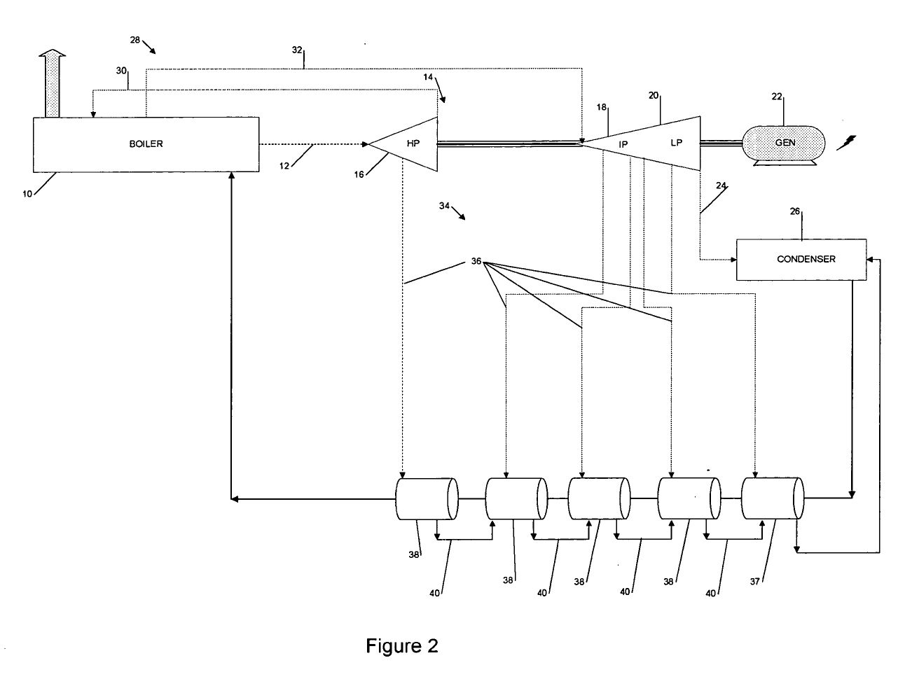

In order to achieve even higher efficiencies of operation, it can be desirable to integrate solar energy into a Rankine cycle power generation system, such as that described above with respect to FIG. 1. FIG. 2 illustrates one embodiment of an integrated Rankine cycle power generation system with integrated solar heat supplementation. In the power generation system embodiment illustrated in FIG. 2, the Rankine cycle power generation system includes similar components to those described above with respect to FIG. 1 integrated with a solar heat system 50 in the regeneration cycle 38.

In the illustrated embodiment, the solar heat system 50 comprises an array of solar heat collectors 52 and a solar working fluid heater 54. A thermal transfer fluid can be heated by the solar heat collectors 52 and circulated in a transfer fluid line 56 to the solar working fluid heater 54. A common single phase thermal transfer fluid can be used in a sensible heat transfer process to both collect the solar heat energy and to add heat into the working fluid stream of the coal plant thus supplanting a portion of the turbine extraction steam used to pre-heat the working fluid. The thermal transfer fluid can be selected to have desirable thermodynamic properties. For example, the thermal transfer fluid can be selected to remain in a single phase during the addition of solar heat in the solar heat collectors 52. Desirably, the heat absorbing transfer fluid is an oil. Typical solar energy transfer fluids for use in a solar heat system can be mineral oil for temperatures up to 600° F. and diphenyl oxidelbiphenyl-based products for temperatures exceeding 600° F.

Referring to FIG. 2, solar heat is collected with solar concentrating heat collectors 52 such as those using solar trough technology or other suitable solar heat collecting devices. In embodiments of solar heat system 52 using solar trough technology, the sun's energy is “line” focused on a heat collection element. In some embodiments, the heat collection element comprises a pipe containing a thermal transfer fluid having thermal properties suitable for the collection of high temperature heat. As noted above, the thermal transfer fluid can be an oil capable of withstanding high temperatures. For example, in some embodiments of solar trough, the oil comprising the thermal transfer fluid is capable of operating at temperatures up to about 730-750° F.

As illustrated in FIG. 2, the thermal transfer fluid heated by the solar collectors 52 is circulated to a solar working fluid heater 54. In some embodiments, the solar working fluid heater 54 can be a closed working fluid heater such as a tube and shell fluid heater. It can be desirable that the solar working fluid heater 54 does not comprise a tank for storage of the heated thermal transfer fluid integrated therewith to form a combined storage tank and working fluid heater, as such a storage tank can add complexity and expense and reduce the efficiency of the energy transfer. However, in some embodiments, as discussed below, a separate reservoir, fluidly coupled to the solar feedwater heater 54 can be provided.

In embodiments where the solar working fluid heater comprises a closed working fluid heater, there can be no mixing of the thermal transfer fluid (which can be an oil) with the working fluid of the power generation system in the solar working fluid heater 54. It can be undesirable for the thermal transfer fluid to mix, via an unintended leak, with the working fluid of the power generation system as impurities in the working fluid can damage the turbine of the power generation system. Accordingly, it can be desirable to reduce the risk of leakage in the solar working fluid heater 54. Desirably, in embodiments of solar heat system 50 with a tube and shell working fluid heater, the heated thermal transfer fluid circulates through the “shell side” of the solar working fluid heater 54. In these embodiments, the working fluid of the Rankine cycle power generation system, because it would likely be at a much higher pressure than the thermal transfer fluid, would thus be on the “tube side” of the solar working fluid heater 54. With this tube and shell configuration, leakage within the solar working fluid heater 54 would tend to flow from the high pressure working fluid to the lower pressure thermal transfer fluid. Thus, even if there were leakage in the solar working fluid heater, the working fluid that is returned to the boiler is unlikely to become contaminated with thermal transfer fluid.

In other embodiments, the solar working fluid heater 54 can include a buffer loop to further reduce the risk of leakage between a thermal transfer fluid and the working fluid of the Rankine power generation system. For example, the solar working fluid heater 54 can include a first heat exchanger to transfer heat energy from the heated thermal transfer fluid circulated from the solar heat collectors 52 to a buffer loop working fluid in a closed working fluid heater such as a tube and shell heater. Desirably, the buffer loop working fluid is the same fluid (e.g. water) used as the working fluid in the power generation system. In these embodiments, the solar working fluid heater 54 can also include a second heat exchanger such as a closed working fluid heater to transfer heat energy from the buffer loop working fluid to the working fluid of the power generation system. Although this buffer loop arrangement can have additional complexity, in some embodiments, the increased safety of minimizing feedwater contamination is worth the extra cost.

In the illustrated embodiment, once passed through the solar working fluid heater 54, cooled thermal transfer fluid is returned to the solar heat collectors 52 for reheating. Advantageously, a closed solar working fluid heater system can heat the working fluid directly with collected solar thermal energy and without additional steam conversion processes.

In some embodiments, the solar working fluid heater 54 can be fluidly coupled to the working fluid heaters 38 serially. Advantageously, where the solar working fluid heater 54 is connected serially, even in conditions where solar energy is inadequate to heat the fluid (e.g. at night or during high overcast periods), the working fluid can pass through the non-functioning heater with relatively small losses. However, the solar working fluid heater 54 remains at an operating temperature and does not require additional energy to bring the heater 54 on line when the flow of thermal transfer fluid is recommenced. In other embodiments, the solar working fluid heater 54 can be fluidly coupled in parallel to the working fluid heaters 38. However, it is contemplated that in some embodiments, a parallel arrangement of solar working fluid heater 54 can add cost and complexity to the working fluid heater train (i.e. it can include valving and control systems to divert the main flow of working fluid away from the solar working fluid heater 54 when there is insufficient solar energy). Moreover, in some embodiments, a parallel arrangement of the solar working fluid heater 54 with the working fluid heaters 52 can undesirably lead to losses from thermal cycling as the solar working fluid heater 54 is brought on and off line due to availability of solar heat energy.

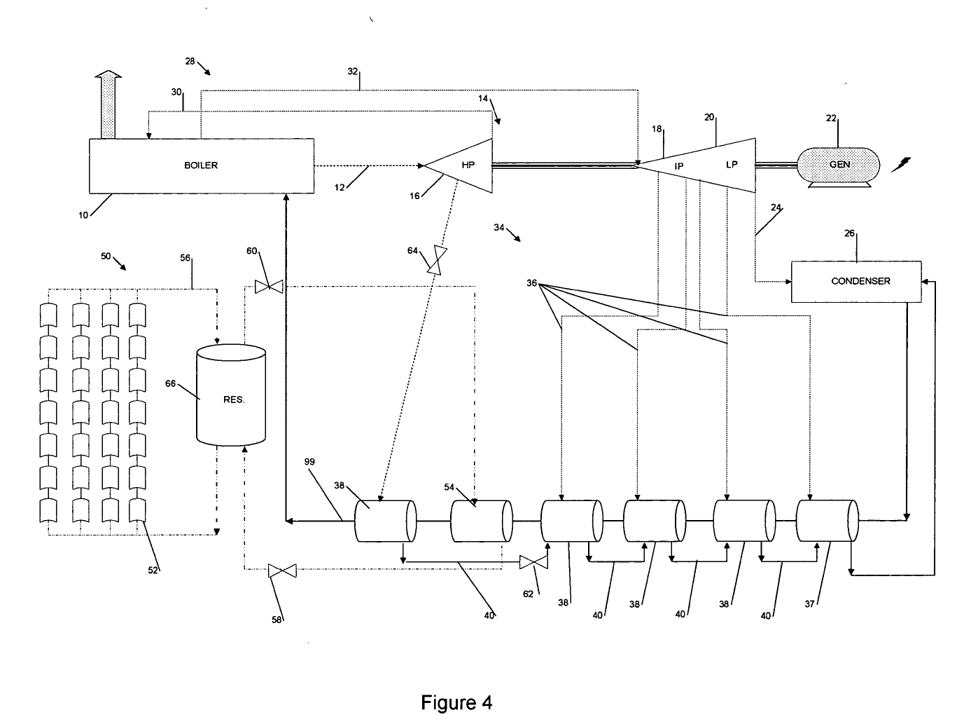

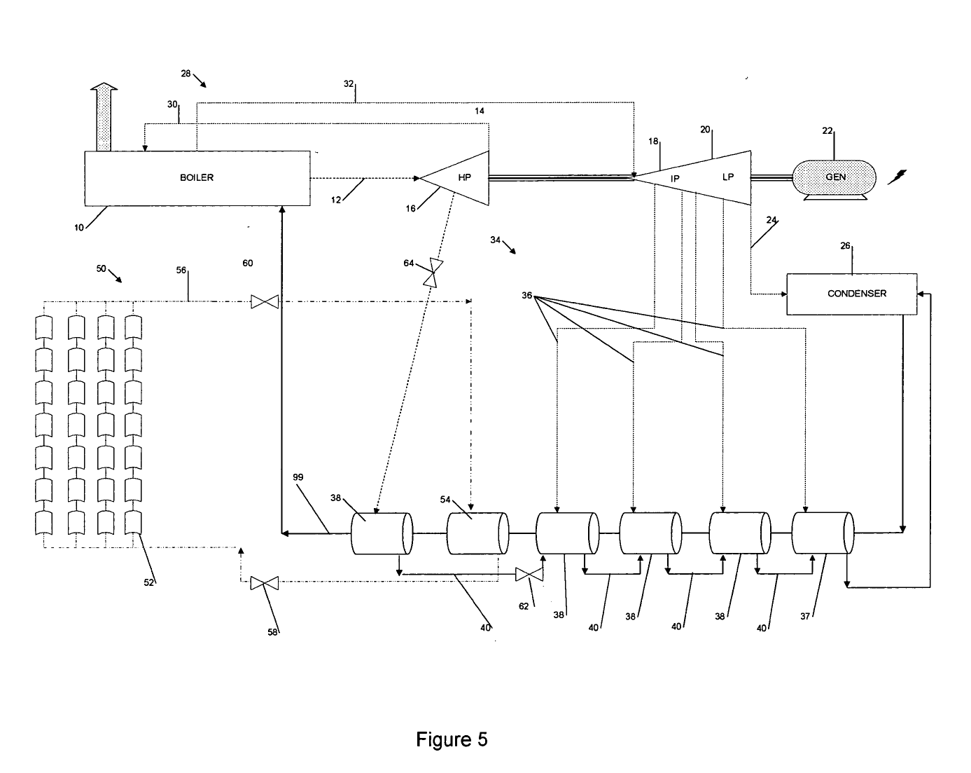

In the illustrated embodiment, the solar working fluid heater 54 is fluidly connected to the flow of condensed working fluid from the condenser 26 to the boiler 10. As illustrated, the solar working fluid heater 54 is fluidly coupled downstream of all of the other working fluid heaters 38. Advantageously, in some embodiments, it can be relatively easy to integrate a solar heat system 50 in this downstream positioning in a retrofit application of a solar heat system 50 to an operational Rankine cycle power generation system. Further this downstream positioning can have thermodynamic efficiency advantages. In view the second law of thermodynamics, it can be beneficial to add heat to a working fluid at the highest possible temperature. Consequently it is desirable in some embodiments that heat from the solar heat system 50 be added to the working fluid at downstream working fluid heater, where the working fluid is at the highest preheated temperature. This furthest downstream working fluid heater is typically operated with the working fluid at the highest pressure and is used to achieve heat addition to the working fluid at the highest temperature. In other embodiments, such as those described with respect to FIGS. 4 and 5, the solar working fluid heater can be placed upstream of one or more working fluid heaters 38.

In some embodiments, flow of the thermal transfer fluid through the solar heat system 50 can be selectively activated and deactivated. In some embodiments, thermal transfer fluid lines can include valves 58, 60 which can be opened, throttled or closed to selectively initiate or terminate a flow of thermal transfer fluid to the solar working fluid heater. Thus, the flow of thermal transfer fluid through the solar working fluid heater 54 can be stopped during severe overcast conditions or during night hours. In the illustrated embodiments, where the solar working fluid heater 54 is fluidly coupled in series with the working fluid heater train, working fluid condensate would still pass through the solar working fluid heater 54, after having already been preheated with the working fluid heaters 38. Thus, the solar working fluid heater 54 can remain at operating temperature even where no thermal transfer fluid is circulating therethrough. In embodiments where the solar working fluid heater 54 is installed in parallel with the working fluid heaters 38, valves can prevent working fluid from passing through the solar working fluid heater 54 when the flow of transfer fluid to the solar working fluid heater is deactivated. As noted above, in some embodiments, this parallel arrangement can add complexities and inefficiencies to the power generation system.

In some embodiments, a working fluid extraction line 36 from the high pressure turbine stage 16 of the turbine 14 can also be selectively activated and deactivated such as with valves 62, 64 on the working fluid extraction line 36 and working fluid heater drain lines 40. Thus, in some embodiments, by deactivating the working fluid extraction from the high pressure turbine stage 16, and activating the flow of thermal transfer fluid in the solar heat system 50, heat energy provided by the solar heat system 50 can substitute for the heat energy that would otherwise be provided by working fluid extracted from the high pressure turbine stage of a turbine (See FIG. 1). In this manner, design operating parameters of the boiler can maintained while additional generating capacity may be realized since more vaporizing working fluid would be available to expand through the turbine 14.

Where the solar heat system 50 is used in place of vaporized working fluid extraction, as described above, additional power can be generated for a given energy input into the boiler 10 such as by burning a fossil fuel. Typically, there are sufficient margins in the turbine 14 and generator 22 of a coal-fueled Rankine cycle power generation system to allow an increase in capacity output resulting from an increase in working fluid flow through the turbine 14 corresponding with deactivating a working fluid extraction line 36 from the turbine 14. In some embodiments, these margins can be on the order of 5% to 10% of additional generating capacity. This additional generating capacity can then be available to provide the additional generation when the Rankine cycle is augmented with solar heat from the solar heat system 50. This increase in turbine flow would result from the reduction in extracted working fluid flows since solar heat is now replacing a portion of the extracted working fluid used for working fluid heating. Consequently, the direct heating of the working fluid through solar thermal energy will allow an increase in turbine output in new facilities where the extra steam turbine capacity is designed into the plant or at existing facilities where there are additional margins in the steam turbine. In power generation facilities where there is no spare capacity in the steam turbine, the solar heat can increase efficiency of the power generation system by displacing fossil fuel usage as less fuel will be required to maintain a predetermined generated power output.

Thus, the systems and methods described herein can be particularly well suited to supply supplemental solar heat to a coal regenerative Rankine cycle power generation system. This type of coal plant can often have surplus capacity in its turbine, generator, and associated equipment. This surplus capacity can be provided in valving out of working fluid heater for maintenance or unexpected outage providing a higher capacity steam flow through the turbine. The operators of a coal regenerative Rankine cycle power generation system would then have additional turbine capacity to handle the excess steam flow. However, there can be a detrimental impact on the heat rate (efficiency) when a working fluid heater is valved out in a coal regenerative Rankine cycle power generation system. The solar heat system 50 described herein can supplement heat input into the Rankine cycle such that this inefficiency is essentially eliminated. Thus, the systems and methods described herein can be particularly advantageous in large scale Rankine cycle power plants that utilize regenerative working fluid stream and are typically in the 100 MW and greater size range.

While the system described herein can be applied as a retrofit to operating power generation systems, if applied to new systems, the boiler 10 can be designed to receive relatively higher working fluid temperatures heated by supplemental solar heat of the solar heat system 50. In these embodiments, efficiencies more closely resembling Carnot efficiencies can be achieved since the power generation system can be configured such that the working fluid temperature entering the boiler 10 can be closer to a saturation temperature of the working fluid. In addition, in these embodiments, higher turbine 14 capability can also be achieved since extracted working fluid can be further reduced, thus permitting higher turbine flows and resulting higher generated electrical energy outputs.

Thermal Transfer Fluid Storage

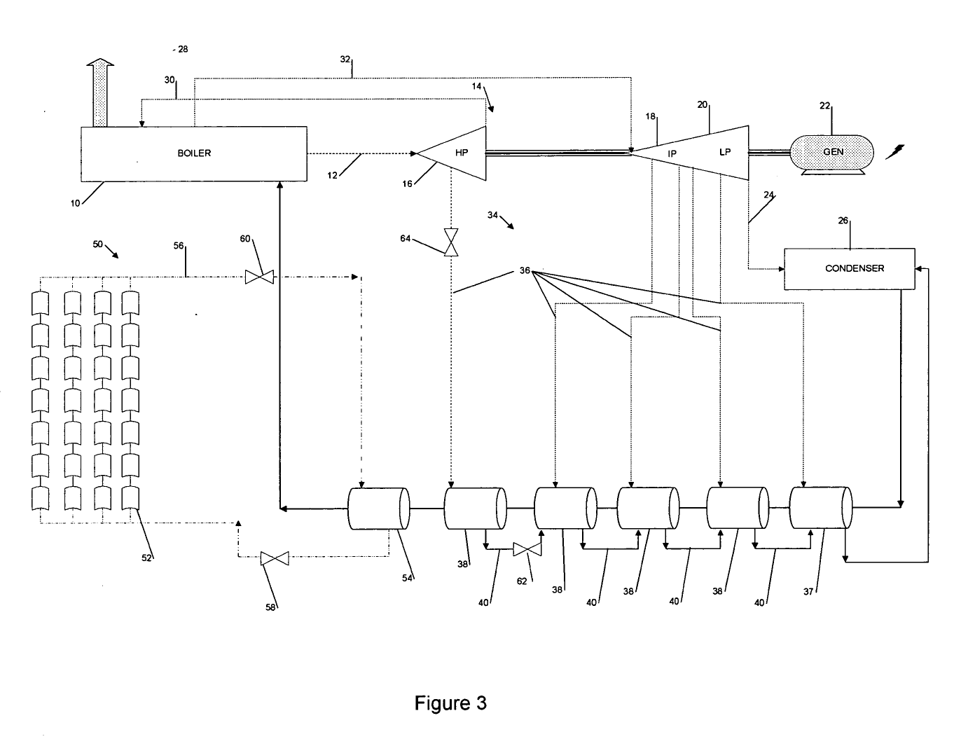

With reference to FIG. 3, other embodiments of power generation system are illustrated in which the thermal transfer fluid is moved from the solar heat collectors 52 into a transfer fluid storage reservoir 66. In some embodiments, the storage reservoir 66 can provide storage for extended operation to obtain enhanced efficiency during sunless periods such as night time or heavy overcast. In some embodiments, the storage reservoir 66 can allow for higher outputs of thermal energy for shorter durations. The storage reservoir 66 can also provide a buffer to smooth out heat spikes and heat loss from the solar collectors.

As seen from the illustrated flow arrows, in the illustrated embodiments, heated transfer fluid can travel from the storage reservoir 66 to the solar working fluid heater 54, and then be returned to the solar heat collectors 52 via the storage reservoir 66. In other embodiments, the thermal transfer fluid can be returned directly to the solar heat collectors 52 from the solar working fluid heater 54.

In some embodiments, the storage reservoir 66 can comprise a single tank using thermocline storage technology. In other embodiments, the storage reservoir 66 can comprise more than one tank. For example, in some embodiments, the storage reservoir 66 can consist of two tanks: one configured to receive for “hot” transfer fluid (from the solar heat collectors 52) and the other configured to receive “cold” transfer fluid (from the solar working fluid heater 54) in order to ensure even flow delivery. In other embodiments, the storage reservoir can be tankless, instead comprising additional length and oversized transfer piping from the solar heat collectors 52 to the solar working fluid heater 54. In these embodiments, the relatively large volume of heat transfer fluid in the pipeline provides storage.

Embodiments of Solar Enhanced Rankine Cycle Power Generation Systems with Auto Adjust

With respect to FIG. 4, in some embodiments, the solar heat system 50 described above with respect to FIG. 2 can be integrated into a Rankine power generation system with the solar working fluid heater 54 upstream of one or more working fluid heaters 38. In the illustrated embodiments, the solar working fluid heater 54 is upstream of one working fluid heater 38, but in other embodiments, the solar working fluid heater 54 can be upstream of two or more working fluid heaters 38.

Where the solar working fluid heater 54 has been positioned between other working fluid heaters 38 in the upstream position illustrated in FIG. 4, the solar heat input into the working fluid stream can be varied by controlling the solar heat collection fluid flow rates and temperature. Specifically, in one operating configuration, the flow rates of one or more pumps circulating the thermal transfer fluid can be slowed to allow thermal transfer fluid to spend a relatively long time in the solar heat collectors 52 to absorb solar energy. In another operating configuration, the flow rates of one or more pumps circulating the thermal transfer fluid can a relatively high flow rate such that the thermal transfer fluid is circulated through the solar heat collectors 52 relatively quickly. Thus, by varying the flow rate of the thermal transfer fluid, the solar heat energy to be added to the power generation system can be varied. In some embodiments, the flow rate can be selected to obtain a maximum energy available from the solar heat available. Regardless of the flow rate, the working fluid heaters 38 downstream of the solar working fluid heater 54 will automatically adjust the extracted vaporized working fluid 99 to maintain the design working fluid temperature and pressure at those locations.

This automatic adjustment can result because a working fluid heater 38 downstream of the solar working fluid heater 54 will condense an amount of extracted vaporized working fluid based on the incoming temperature of the preheated condensed working fluid. As the temperature of the preheated condensed working fluid stream increases due to addition of heat energy from the solar working fluid heater 54, the amount of extracted vaporized working fluid that is extracted from the turbine 14 by a working fluid heater 38 located downstream of the solar working fluid heater 54.

Thus, this automatic adjustment of the working fluid heaters 38 allows substantially all solar heat collected to be used. Energy from the solar heat collection is rarely lost due to the lack of capacity to process and use the solar heat. Thus, the total amount of solar heat that can be collected on days when the solar insolation may exceed the design conditions of a working fluid heater 38 downstream of the solar working fluid heater 54 can be utilized in an efficient manner. Additionally, the automatic adjusting of the working fluid heaters 38 downstream of the solar working fluid heater 54 novelty allows the Rankine cycle to automatically compensate for modulation of the solar heat input. Thus, in the embodiments of solar-supplemented Rankine cycle power generation system illustrated in FIG. 4, the solar heat collectors 52 can be directly fluidly connected to the solar working fluid heater 54 without a storage reservoir to buffer modulation in the solar heat input.

Automatic Adjustment with Transfer Fluid Storage Reservoir

With reference to FIG. 5, in some embodiments, the solar-supplemented Rankine cycle power generation system can have a transfer fluid storage reservoir 66 as described above with respect to FIG. 3. In these embodiments, the storage reservoir 66 can extend the operation time of the solar heat input to periods of low sunlight. In some embodiments, the storage reservoir 66 can provide a relatively short duration burst of relatively high solar heat input into the Rankine cycle power generation system.

Advantageously, the integrated Rankine cycle power generation systems and solar systems described above with respect to FIGS. 2-5 can achieve lower electricity costs by utilizing the existing power plant components and infrastructure, primarily the turbine and generator of the Rankine cycle power plant. Thus, the solar heat systems described herein can be easily applied as a retrofit to enhance the efficiency of an operating Rankine cycle power generation system. Or, in some embodiments, a Rankine cycle power generation system can be constructed with a solar heat system to supplement the regeneration cycle. Advantageously, a solar boiler is also not necessary since solar heat energy can be directly transferred to the Rankine cycle power generation system via a common fluid that is used for both solar heat collection and heating the working fluid stream in the Rankine cycle.

Further efficiency advantages can be obtained using the integrated power generation systems described herein because all of the working fluid heating in the solar heat system is provided by solar sensible heat. Accordingly, there is higher solar system efficiency as compared with systems that use solar heat to vaporize a working fluid, since no heat of evaporation (latent heat) is solar provided. Thus, the heat transfer mechanism provided by the solar heat system allows heat transfer with smaller temperature differences than otherwise would be realized if the solar heat was used for evaporation of a working fluid also. The heat of evaporation for the Rankine cycle occurs in the boiler and, consequently, entropic losses associated with this flashing are already accounted for in the fossil-fueled Rankine cycle. Thus, inputting solar-provided sensible heat to an existing Rankine cycle can have efficiency advantages as compared to a solar cycle which must provide its own latent heat for flashing.

Although certain embodiments and examples have been described herein, it will be understood by those skilled in the art that many aspects of the systems and methods shown and described in the present disclosure may be differently combined and/or modified to form still further embodiments. Additionally, it will be recognized that the methods described herein may be practiced using any systems or devices suitable for performing the recited steps. Such alternative embodiments and/or uses of the methods, systems, and devices described above and obvious modifications and equivalents thereof are intended to be within the scope of the present disclosure. Thus, it is intended that the scope of the present inventions should not be limited by the particular embodiments described above, but should be determined only by a fair reading of the claims that follow.

What is claimed is:

1. A method for generating power, the method comprising:
heating a thermal transfer fluid with solar energy in a single phase system,
transferring heat energy from the heated thermal transfer fluid to a working fluid in a Rankine cycle power generation system to preheat the working fluid,
wherein heat energy is transferred from the heated thermal transfer fluid to the working fluid in a regeneration portion of the Rankine cycle power generation system in a closed loop system of a solar working fluid heater wherein the solar working fluid heater is not located in a storage tank, the solar working fluid heater fluidly coupled in series with and downstream of a first working fluid heater.

2. The method of claim 1, wherein the thermal transfer fluid comprises an oil.

3. The method of claim 1, wherein heating the thermal transfer fluid comprises collecting solar heat with a solar trough.

4. The method of claim 2, wherein collecting solar heat comprises line focusing solar energy on a heat collection element.

5. The method of claim 1, further comprising collecting the heated transfer fluid in a reservoir.

6. The method of claim 5, wherein the reservoir comprises a conduit transporting the heated thermal transfer fluid.

7. The method of claim 1, wherein transferring heat energy comprises passing the heated transfer fluid through first flow conduit of a working fluid heater; and passing working fluid through a second flow conduit of the working fluid heater.

8. The method of claim 1, wherein heating a thermal transfer fluid comprises heating the thermal transfer fluid to a predetermined temperature.

9. The method of claim 1, wherein heating a thermal transfer fluid comprises operating a pump circulating the thermal transfer fluid through at least one solar heat collector at a first flow rate.

10. The method of claim 1, wherein the Rankine cycle power generation system has an operational fuel input and an operational power output, and wherein transferring heat energy from the heated thermal transfer fluid to the working fluid increases power output of the Rankine cycle power generation system to an increased power output greater than the operational power output.

11. The method of claim 1, wherein the Rankine cycle power generation system has an operational fuel input and an operational power output, and wherein transferring heat energy from the heated thermal transfer fluid to working fluid reduces a fuel input requirement of the Rankine cycle power generation system to a reduced fuel input less than the operational fuel input.

12. The method of claim 1, wherein transferring heat energy from a thermal transfer fluid to a working fluid comprises:
transferring heat energy from the thermal transfer fluid to a buffer loop working fluid in a closed working fluid heater; and
transferring heat energy from the buffer loop working fluid to the working fluid of the power generation system in a closed working fluid heater.

13. The method of claim 12, wherein the buffer loop working fluid comprises the same fluid as the working fluid of the power generation system.

14. A system for generating power comprising
a boiler configured to vaporize a working fluid;
a turbine fluidly coupled to the boiler and configured to be driven by the vaporized working fluid;
a condenser fluidly coupled to the turbine and configured to condense the working fluid that has driven the turbine;
a generator operatively coupled to the turbine;
a regeneration cycle fluidly coupled to the condenser and the boiler and comprising:
a first working fluid heater configured to preheat the condensed working fluid from the condenser, the first working fluid heater configured to receive partially expanded vaporized working fluid from the turbine and to transfer heat energy from the partially expanded vaporized working fluid to the condensed working fluid; and
a second working fluid heater serially coupled to the first working fluid heater and configured to preheat the condensed working fluid from the condenser, the second working fluid heater configured to receive a thermal transfer fluid from a solar heat collection system in a closed loop system and to transfer heat energy from the solar heat collection system to the condensed working fluid.

15. The system of claim 14, wherein the solar heat collection system comprises a plurality of solar collectors.

16. The system of claim 14, wherein the solar heat collection system comprises a thermal transfer fluid reservoir.

17. The system of claim 16, wherein the thermal transfer fluid reservoir is isolated from the second working fluid heater.

18. The system of claim 14, wherein the second working fluid heater is fluidly coupled to the boiler downstream of the first working fluid heater on a working fluid return line.

19. The system of claim 14, further comprising a third working fluid heater fluidly coupled to the boiler downstream of the second working fluid heater on a working fluid boiler return line, the third working fluid heater configured to receive partially expanded vaporized working fluid from the turbine and to transfer heat energy from the partially expanded vaporized working fluid to the condensed working fluid.

20. The system of claim 14, wherein the regeneration cycle further comprises a valve fluidly coupling the second working fluid heater to the solar heat collection system and configured to selectively activate flow of thermal transfer fluid to the second working fluid heater.

21. The system of claim 14, wherein the second working fluid heater is serially fluidly coupled to the first working fluid heater such that the second working fluid heater is configured to further heat the condensed working fluid from the first working fluid heater.
